(19) United States
(12) Patent Application Publication
(10) Pub. No.: US 2025/0326231 A1
(43) Pub. Date: Oct. 23, 2025

(54) CONTAINER

(71) Applicant: CANON KABUSHIKI KAISHA, Tokyo (JP)

(72) Inventors: TAKASHI TERAGAKI, Kanagawa (JP); DAISUKE NAKAGAWA, Kanagawa (JP)

(21) Appl. No.: 19/174,059

(22) Filed: Apr. 9, 2025

(30) Foreign Application Priority Data
Apr. 18, 2024 (JP) 2024-067338

(51) Int. Cl. B41J 2/175

(52) U.S. Cl. CPC B41J 2/17566; B41J 2/17509; B41J 2/17513; B41J 2/17523; B41J 2/17553; B41J 2002/17516

(57) ABSTRACT

A container is used, which includes a storage portion configured to store liquid ink and a supply portion configured to supply the stored ink to a recording device, the storage portion has a layer structure having a resin layer that is an inner layer and a paper layer that is a layer facing the outside of the container, the paper layer is provided with an opening, and the ink stored in the storage portion can be visually recognized from the outside of the container through the opening. The resin layer has a greater thickness in a region corresponding to the opening than in other regions. This feature allows the transition from plastic containers to paper containers to be promoted.

### BACKGROUND OF THE INVENTION

### Field of the Invention

The present invention relates to a container.

### Description of the Related Art

Currently, plastic containers are widely used as ink containers for ink jet printers. However, plastic products have relatively high recycling costs and significant environmental impact when they are disposed of. From the perspective of environmental considerations, reducing the use ratio of plastic and using paper as an alternative has been considered. The base material of paper containers or containers with an increased proportion of paper (hereinafter collectively referred to as paper containers, where paper is the primary structural material) is paper and opaque. Therefore, while paper is used for liquid containers, there is no way to check the content. A general way to address this is to cut out a part of the container to create a window section.

In the disclosure of Japanese Patent Application Publication No. 2016-008060, a window portion is formed by cutting out a part of a paper container processed to be able to contain liquid, and a film with a gas barrier property or protective film is adhered to the cut-out window portion from the inside of the container. In this way, a transparent window portion can be provided in the paper container, which makes it easier to view the content.

### SUMMARY OF THE INVENTION

However, Japanese Patent Application Publication No. 2016-008060 discloses that the film or protective layer is adhered using an adhesive from the inside of the paper container. Therefore, the adhesive part may be deteriorated by ink. The film or protective film may peel or become damaged due to ink-induced deterioration of the adhesive part.

With the foregoing in view, it is an object of the present invention to suppress ink-induced deterioration of the container when providing an opening to allow the ink to be visually recognized in a container including a resin layer for storing the ink and a paper layer surrounding the resin layer.

The present invention provides a container comprising:
a storage portion configured to store liquid ink; and
a supply portion configured to supply the ink stored in the storage portion to a recording device, wherein
the storage portion has a layer structure having a resin layer that is an inner layer and a paper layer that is a layer facing the outside of the container,
the paper layer is provided with an opening,
the ink stored in the storage portion can be visually recognized from the outside of the container through the opening, and
the resin layer has a greater thickness in a region corresponding to the opening than in other regions.

According to the present invention, when an opening through which ink can be visually recognized is provided in a container including a resin layer for storing the ink and a paper layer surrounding the resin layer, ink-induced deterioration of the container can be suppressed.

Further features of the present invention will become apparent from the following description of exemplary embodiments with reference to the attached drawings.

### BRIEF DESCRIPTION OF THE DRAWINGS

FIG. 1 is a schematic view for illustrating ink-induced deterioration of an adhesion part, which is the problem to be solved by the disclosure;

FIGS. 2A to 2C are schematic views of ink containers to which the technical idea according to the disclosure can be applied;

FIG. 3 is a schematic view of a window in an ink container to which the technical idea of the present disclosure can be applied;

FIG. 4 is a schematic view of a printer to which an ink container according to the present disclosure can be applied;

FIG. 5 is a schematic view illustrating how ink is supplied from the ink container according to the present disclosure;

FIG. 6 is a schematic view of an example of layer arrangement in a first embodiment;

FIG. 7 is a schematic view of an example of cut-out window structure in the first embodiment;

FIG. 8 is a schematic view of an example of the appearance of a cut-out window in the first embodiment;

FIGS. 9A and 9B are schematic views of examples of a cut-out window structure in the first embodiment;

FIG. 10 is a schematic view of an example of the structure of a film which covers the window in the first embodiment;

FIG. 11 is a schematic view of an example of the appearance of the film which covers the window in the first embodiment;

FIGS. 12A to 12E are schematic views of examples of a window shape to which the technical idea of the present disclosure can be applied;

FIG. 13 is a schematic view of an example of the window shape in the first embodiment;

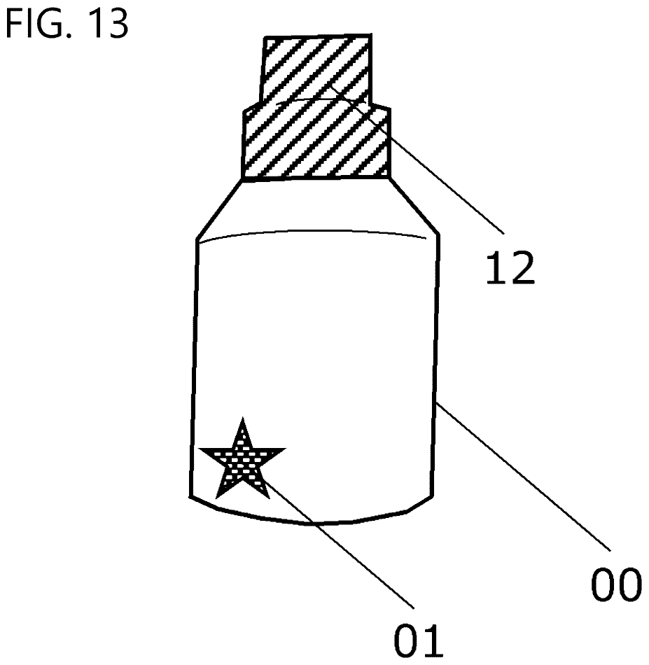

FIG. 14 is a schematic view of an example of a cut-out window structure in a second embodiment;

FIG. 15 is a schematic view of an example of the appearance of a cut-out window in the second embodiment;

FIGS. 16A and 16B are schematic views of examples of the cut-out window structure in the second embodiment;

FIG. 17 is a schematic view of an example of a cut-out window structure in a third embodiment;

FIG. 18 is a schematic view of an example of a cut-out window structure in a fourth embodiment;

FIGS. 19A to 19D are schematic views of bottle-shaped containers to which the technical idea of the present disclosure can be applied;

FIGS. 20A and 20B are schematic views of roof-shaped containers to which the technical idea of the present disclosure can be applied;

FIGS. 21A to 21C are schematic views of bag-shaped containers to which the technical idea of the present disclosure can be applied;

FIGS. 22A to 22C are schematic views of brick-shaped containers to which the technical idea of the present disclosure can be applied;

FIGS. 23A and 23B are schematic views of can-shaped containers to which the technical idea of the present disclosure can be applied; and

FIGS. 24A and 24B are schematic views of an opening/closing member provided at the cut-out window.

### DESCRIPTION OF THE EMBODIMENTS

Now, preferred embodiments of the present disclosure will be described in detail with reference to the drawings. Meanwhile, the dimensions, materials, shapes, and relative arrangements of the components in the following description of the embodiments are, unless stated otherwise, not intended to limit the scope of this invention to those described. The materials, shapes, and other characteristics of components described once in the following, unless otherwise specified, remain the same throughout the subsequent description. Well-known or known techniques in the art can be applied to configurations and steps that are not specifically illustrated or described.

In the following description, a window is provided on the side of the container, but this configuration is merely illustrative. Although an ink container for an ink-jet printer will be described in the following, the present disclosure can also be applied to ink containers other than those for an ink-jet printer.

In the following description, the term “paper container” refers to a container primarily made of paper. However, to prevent ink-induced deterioration of the paper, a combination of paper and a non-paper material is used. The paper container disclosed herein includes, for example, a container including a paper layer and a resin layer such as plastic bonded, combined, or laminated together. The container in the present disclosure is provided by replacing at least part of the container made entirely of resin with paper. More preferably, the paper container herein is preferably composed of at least 50% paper at least in terms of weight or volume.

Similarly, in the following description, the component referred to as the “paper layer” is not necessarily entirely made of paper. In some cases, the paper layer may include a paper material as a major constituent material which is coated with or pinched between at least one resin layer or film layer. Similarly, in the following description, the component referred to as the “resin layer” is not necessarily entirely made of a single material. Similarly, in the following description, the component referred to as the “film or resin film” is not necessarily entirely made of a single material. The component may refer to a material having a layer structure including a plurality of materials having different characteristics laminated on each other.

### Description of Problem to be Solved by Present Disclosure

The problem to be solved by the present disclosure will be described in a supplemental manner. Plastic containers provided with layers of aluminum or a resin film having a high gas barrier property have been widely used as conventional ink containers for an ink-jet printer 20. However, there has been a movement to regulate the use of plastics and reduce their amount with consideration for the environment. Paper containers have attracted attention as an alternative to plastic containers but since the contents of paper containers, such as ink, are not visible from the outside, it is difficult to check the color, condition, and remaining amount.

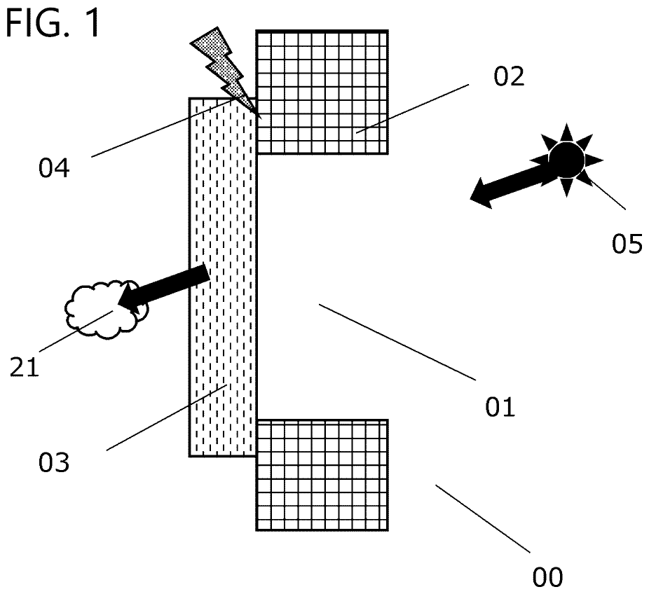

In order to solve the problem, there is a method for providing a window portion as an opening in a part of the container and adhering a transparent film from the inside of the container, so that the ink can be seen therethrough. FIG. 1 shows a partial cross-section of the structure of an ink container 00 according to the conventional technique, where the left side on the surface of the sheet is the side where the ink is stored (inside of the container), and the right side on the surface of the sheet is the atmosphere side (the outside of the container). A resin film 03 is adhered from the inside to a cut-out window 01 provided on the paper base material 02 of the container, and the remaining amount of ink can be visually recognized by a user while preventing the ink from flowing out from the inside to the outside.

However, if, for example, the ink has a strong property, such as being acidic or alkaline, or if the ink is stored for a long period of time, there is a possibility that a deteriorated area 04 may form at the adhesion part between the resin film 03 and the paper base material 02.

In the disclosure of Japanese Patent Application Publication No. 2016-008060, a sealing sheet with a gas barrier property is thermally bonded to the cut-out window portion from the inside, and a protective film is further laminated thereon, in order to provide a gas barrier property and prevent ink-induced deterioration at the adhesion part.

However, the technique disclosed in Japanese Patent Application Publication No. 2016-008060 fails to prevent the protective sheet from being deteriorated by the ink and peeling off. If the protective sheet peels off, deterioration of the sealing sheet cannot be prevented.

Further, the technique disclosed in Japanese Patent Application Publication No. 2016-008060 does not take into consideration of ink degradation and discoloration caused by external light 05. In other words, as indicated by the ink degradation 21 in FIG. 1, the ink irradiated with light through the window may be altered by incident light from the external environment, and the ink may no longer fulfill its intended purpose. It is also necessary to consider the degradation and discoloration of the ink due to the external light 05.

Therefore, with the foregoing problem in view, it is an object of the present disclosure to prevent ink-induced deterioration of an adhesion part and suppress the peeling of a film in the ink container 00 having the cut-out window 01. Another object of the present disclosure is to prevent ink degradation due to external incident light.

### Structure of Ink Container

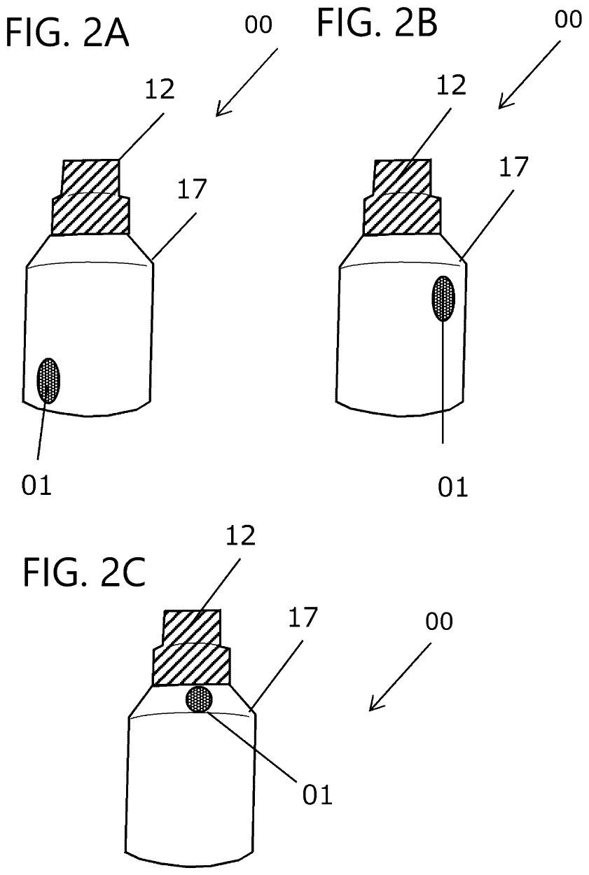

FIGS. 2A and 2B are schematic views of an example of the structure of the ink container 00, which is a paper container provided with the cut-out window 01. The ink container 00 has a container unit 17 for storing ink, and the opening of the container unit 17 is sealed by a plug 12. The cut-out window 01 may be provided in a lower position of the container unit 17 as shown in FIG. 2A or in an upper position of the container unit 17 as shown in FIG. 2B.

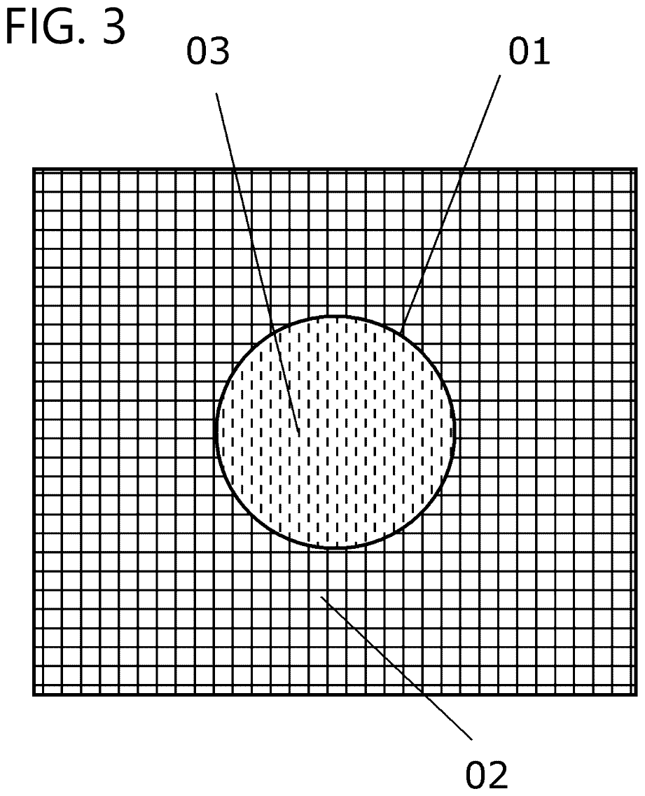

FIG. 3 is a partial schematic view of the cut-out window 01 as viewed from the outside of the container. The paper layer 10 is cut-out at the part of the cut-out window 01 as the window portion, through which a transparent resin film 03 (the resin layer, the film layer) and the content inside the container can be checked. Note that in the present disclosure, the name “cut-out window” may be used for the window that is the opening provided in the paper layer 10, but the method for providing the window is not limited to cutting. For example, a plurality of papers may be adhered to leave an opening. When forming the paper layer 10 by molding a pulp mold with a die, an opening may be formed from the beginning.

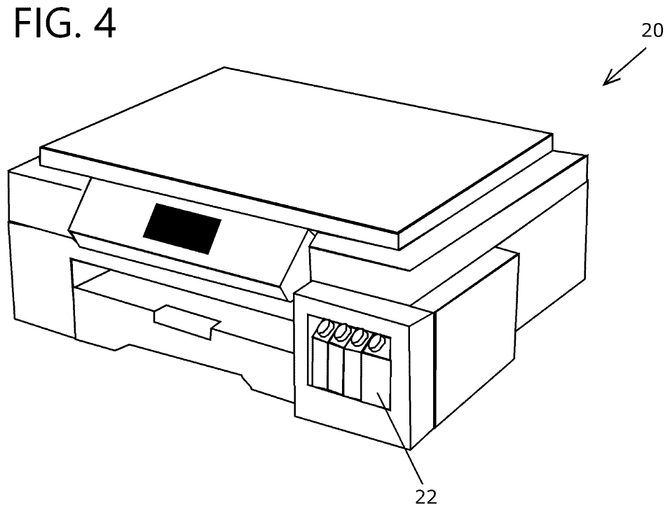

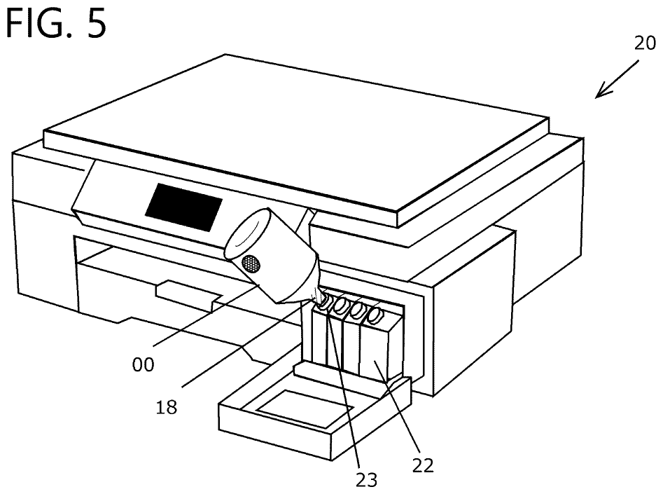

FIG. 4 is a schematic view of an ink-jet printer 20 to which the ink container 00 according to the present disclosure can be applied. FIG. 5 is a schematic view illustrating how ink is supplied into the ink-jet printer 20 from the ink container 00 according to the present disclosure. When refilling the ink-jet printer 20 with ink, the user opens the plug 12 of the ink container 00 to expose the spout 18 and removes the cap from the filling opening 23 of the tank 22 for the color to be replenished. Then, the spout 18 is inserted into the filling opening 23 and ink is injected.

It should be noted that the filling structure is merely illustrative. The structure of the supply portion for taking out ink supplied to the ink-jet printer 20 from the ink container 00 is not limited to the spout 18. For example, an opening sealed by a cap or seal may be provided, and the opening may be opened at the time of filling to move the ink through a syringe or tube. Similarly, the structure of the receiving portion for receiving ink supplied from the supply portion in the ink-jet printer 20 or the tank 22 is not limited to the filling opening 23. The ink container 00 in the present disclosure can be widely applied as long as it is an image forming apparatus (recording apparatus) using liquid ink or a tank disposed in the image forming apparatus.

### First Embodiment

Now, the first embodiment will be described with reference to FIGS. 2A to 2C, 6, and 12A to 12E. As described above, FIGS. 2A to 2C show an example of the ink container 00, in which a spout portion to serve as an ink discharge port is provided at the top of the cylindrical surface, and the spout portion is plugged with the plug 12. By providing the cut-out window 01 on the cylindrical surface, the content can be checked.

### Structure for Preventing Ink-Induced Deterioration

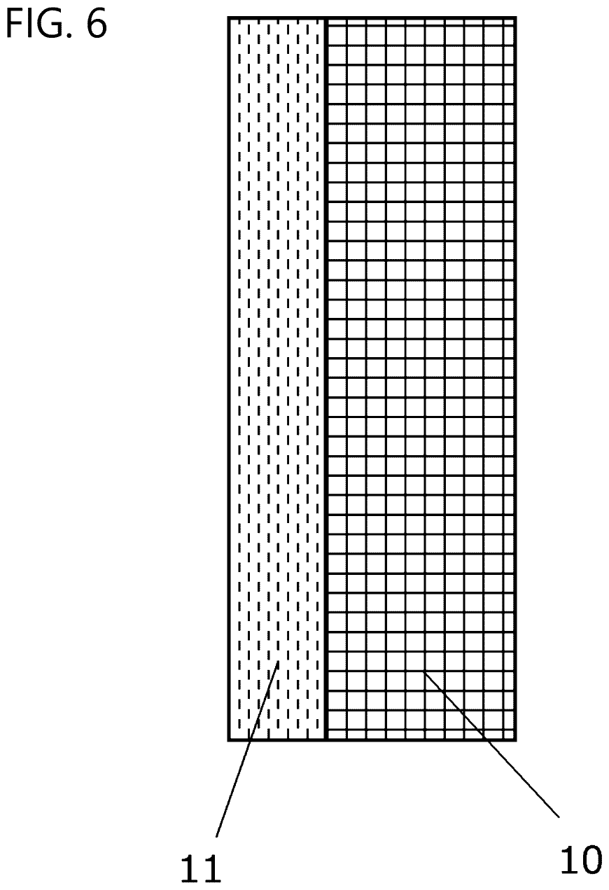

FIG. 6 shows an example of the layer structure of the ink container 00. FIG. 6 shows a partial cross-section of the container at a portion that is not the window, in which the left side of the sheet surface represents the inner layer of the container (the side in contact with the ink) and the right side represents the outer layer (the side in contact with the atmosphere). Thus, the ink container 00 has a structure in which at least the resin layer 11 resistant to the ink-induced deterioration and the paper layer 10 are laminated on each other.

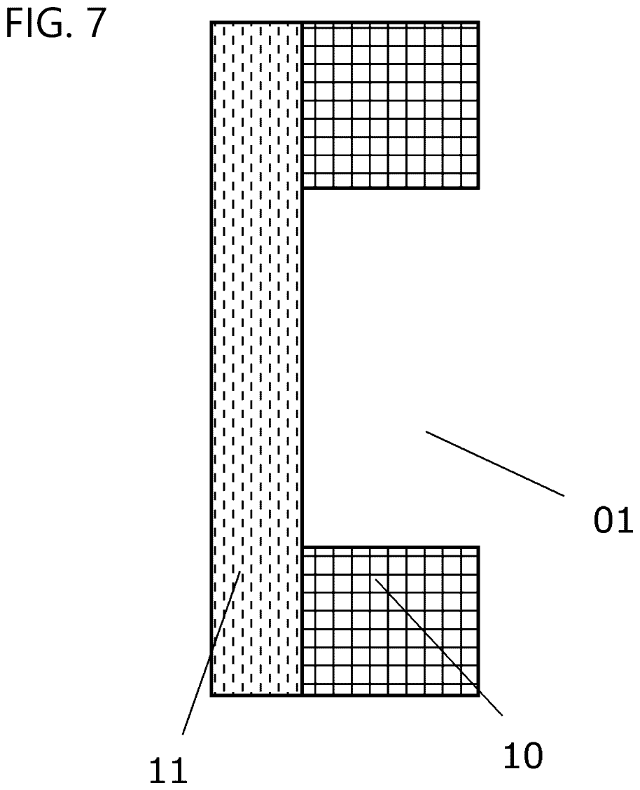

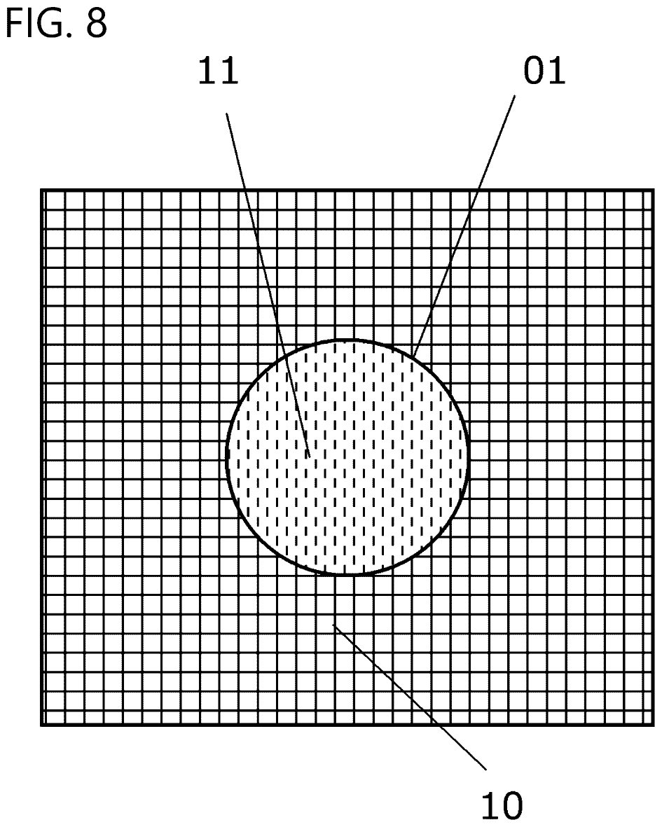

FIG. 7 shows a partial cross-section of the portion provided with the window portion. As shown, the cut-out window 01 is provided only in the paper layer 10, and no cut-out is provided in the resin layer 11. FIG. 8 shows the cut-out window 01 as viewed from the outside. Note that the resin layer 11 spreads uniformly over the entire inside of the container unit 17 in order to prevent ink leakage.

From the viewpoint of environmental considerations, as for the thickness of the layers of the container, the outer paper layer 10 is preferably thicker than the inner resin layer 11.

According to the structure, since the resin layer 11 is uniformly provided inside the window portion, there is no adhesive portion. Therefore, when the content has a property such as acidic or alkaline, the peeling of the film caused by deterioration at the adhesion part as in the conventional case does not occur.

### Structure for Reducing Effect of External Light

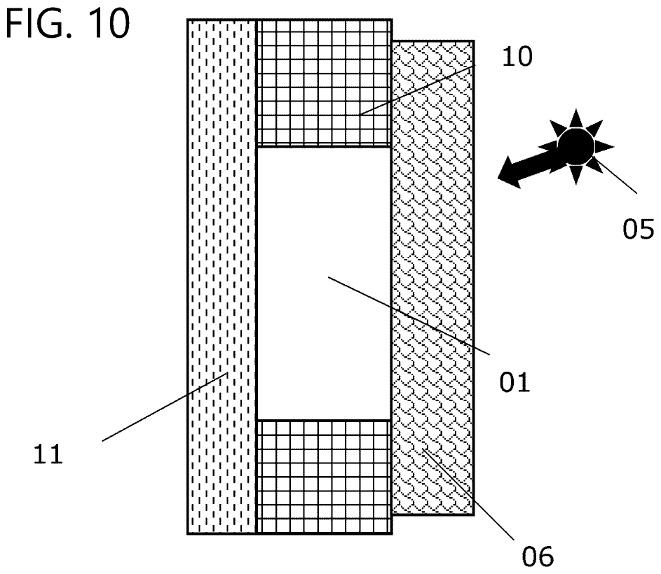

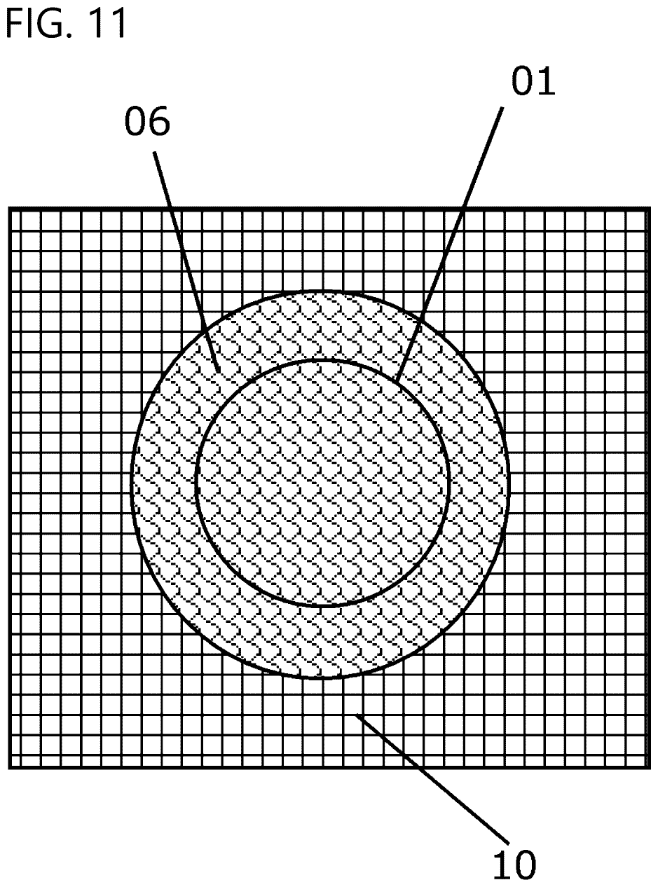

Next, a structure for preventing ink degradation attributable to incident light from the outside will be described. FIG. 10 illustrates a partial cross-section showing a state in which a transmittance reducing film 06 is further provided in the window portion from the state shown in FIG. 7. As shown, the transmittance reducing film 06 is adhered to the area corresponding to the cut-out window 01 from the outside of the container. The transmittance reducing film 06 according to the embodiment is a film having a low transmittance for all light rays. FIG. 11 is a view of the appearance of the cut-out window 01 in a state where the transmittance reducing film 06 is attached from the outside of the container. The size of the transmittance reducing film 06 is at least large enough to cover the cut-out window 01. When the film is adhered at the peripheral edge, the size is slightly larger than the cut-out window 01 as shown in the figure.

In this way, the transmittance reducing film 06 is provided to cover the cut-out window 01, and therefore if external light 05 such as sunlight enters through the window portion, ink degradation can be suppressed. The size of the transmittance reducing film 06 is at least larger than the contour of the window. The transmittance reducing film 06 is preferably larger in size and in the same shape as the contour shape of the window. The adhesion may be carried out with an adhesive, or a layer corresponding to thermal bonding may be provided in the layered structure of the transmittance reducing film 06.

As for the optical characteristic of the transmittance reducing film 06, it is preferable that the line indicating the amount of the content liquid can be visibly inspected to allow the user to check the amount of the ink, and the color of the content can be distinguished. For example, a translucent film may be used.

Among natural light, ultraviolet rays have the greatest impact on the degradation of ink. Therefore, a film obtained by laminating films that reduce ultraviolet light transmittance may be used as the transmittance reducing film 06.

### Arrangement and Shape of Window Section

FIG. 2A illustrates an example of the position where the window portion is formed in the ink container 00 according to the present disclosure. The window portion is preferably positioned in a location that allows easy viewing of the content during product display or upon opening. Thus, in the bottle shown in FIG. 2A, the window portion is provided on an easily visible cylindrical surface. In FIG. 2B, the window portion is provided on the side. According to this arrangement, when ink is injected with the ink container 00 upside down, the residual amount of ink can be easily checked during or after injection.

FIG. 2C illustrates another example of the position where the window portion is formed. In this manner, the amount of the remaining ink during or after the ink injection can be easily checked by the window portion provided near the conical portion near the discharge port rather than the cylindrical surface. With the structure in FIG. 2C, it can be emphasized that the container holds the content at the beginning of use of the container.

As the size of the window portion increases, the visibility increases, but this also leads to reduced strength and an increased incidence of external light. The ratio of the area occupied by the cut-out window 01 in the area of the paper layer 10 of the outer surface of the ink container 00 is preferably 10% or less from the viewpoint of container strength. However, from the viewpoint of increasing visibility, for example, a circular window preferably has a diameter of at least 5 mm and an area of at least 20 mm².

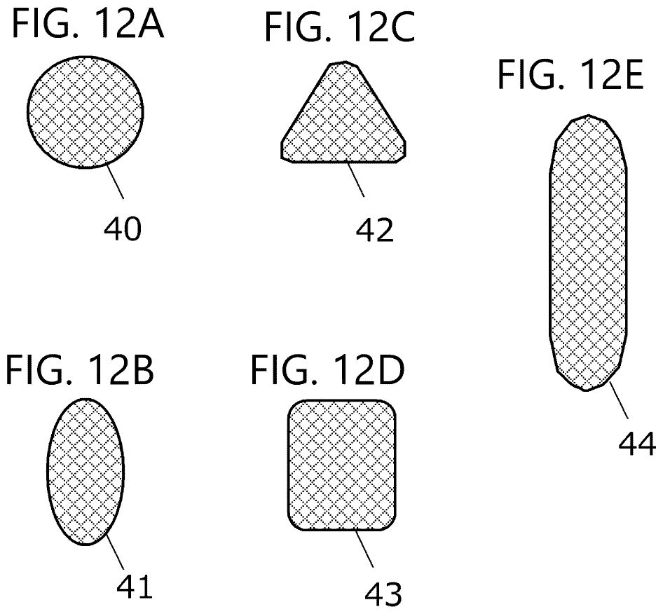

FIGS. 12A to 12E illustrate examples of the shape of the window. In order to prevent damage due to external force, it is preferable that the window is not provided with a corner. That is, the window preferably has a circle or oval shape with no corner as shown in FIG. 12A or 12B or when a triangle, a square or a rectangle as shown in FIGS. 12C to 12E, it is preferable that the corners are rounded by R machining. An elongated window in the vertical direction (in the direction of gravity), as shown in FIG. 12E, is suitable for checking the content volume when the container is in its normal installation position.

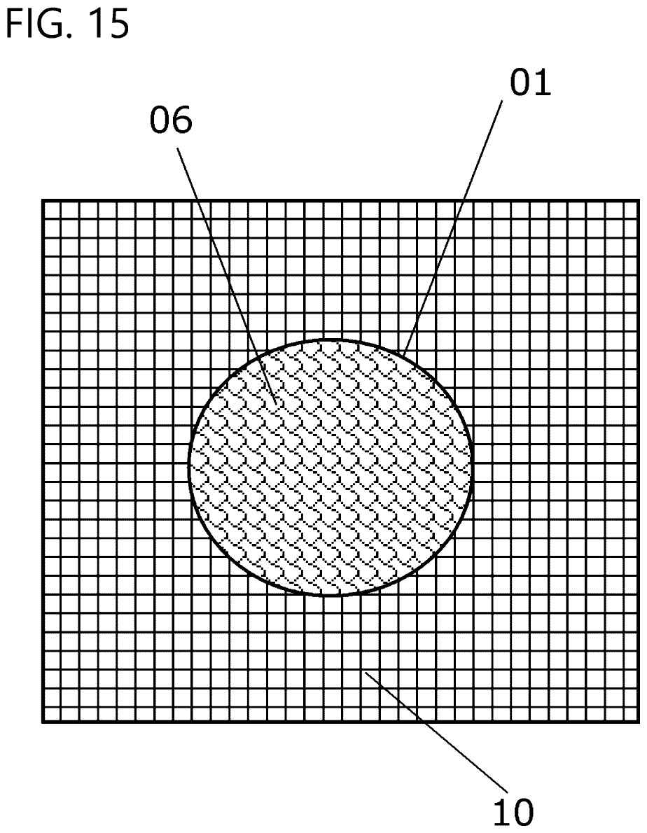

A window shape with a high level of design, such as the star shape shown in FIG. 15, may also be adopted. In this case, a window frame with a star-shaped outline is preferably attached on the outside of the transmittance reducing film 06.

As for the number of windows, at least one window is provided per container. When a container has a plurality of surfaces, one window may be preferably provided on each surface, so that the volume can be checked from various directions.

### Required Properties

The required properties and optimum ranges for the ink container 00 will be described. The container provided with a window portion is required to have resistance to the properties of ink (e.g., acidity, alkalinity), gas barrier properties, barrier properties against water vapor, opacity to visible light and ultraviolet rays, internal visibility for checking the presence and remaining amount of the content, and strength retention performance against load.

The properties such as acid resistance and alkali resistance are provided by the resin layer 11. For this purpose, the resin layer 11 may include a polyethylene (PE) layer. Alternatively, materials such as polyvinyl chloride, polystyrene, or polypropylene may also be used.

The gas barrier properties are provided by the resin layer 11. For this purpose, the resin layer 11 may have a layer of a PET resin. Alternatively, films transparent-vapor-deposited with silicon oxide or alumina as well as polyvinyl alcohol or polyvinylidene chloride may also be used. The performance is preferably an oxygen permeability of 0.10 cc/m²·day or less, measured according to the test method specified in JIS K 7126.

Note that the resin layer 11 must be made of a material that transmits light to the extent that at least the remaining amount of the content can be visually recognized. Here, it is important for a container for liquid ink that the residual amount of the content can be visually recognized, and unlike a food container, it is not always necessary that the color of the content can be visually recognized accurately. Specifically, light transmittance of approximately 20% in visible light is generally sufficient, and it may be even lower (e.g., 10%). In this way, the quality of the ink can be preserved over a longer period of time. Here, the term “light transmittance” refers to a value that takes into account the attenuation of light by the transmittance reducing film 06 as well as by the resin layer 11. More specifically, if the resin layer 11 itself attenuates a significant amount of light, the attenuation rate of the transmittance reducing film 06 does not need to be particularly high.

The barrier properties against water vapor are provided by the resin layer 11. For this purpose, the resin layer 11 may have a layer of a polyolefin resin. Alternatively, a film transparent-vapor-deposited with polyvinylidene chloride, silicon oxide, and alumina may be used. The performance is preferably an oxygen transmittance of 0.5 g/m²·day or less in the test method specified in JIS K 7129.

The opacity to visible light and ultraviolet rays is provided by the transmittance reducing film 06. For this purpose, the transmittance reducing film 06 may have a layer of an opaque PET film. It is also possible to enhance performance by increasing crystallinity to achieve opacity. As for the performance, the total light transmittance of the transmittance reducing film 06 is preferably 40% or less for light by a test method in accordance with “JIS K 7361-1/Plastics-Determination of the total luminous transmittance of transparent materials”. From the viewpoint of visibility, the content can be clearly checked by relatively increasing the light transmittance in the wavelength range of 360 nm to 400 nm.

As for the opacity to ultraviolet rays, the transmittance reducing film 06 may include a layer of resin film containing a UV absorber. Examples of the UV absorber include benzotriazole-based materials. As for the performance, the ultraviolet light transmittance of the transmittance reducing film 06 is preferably 40% or less for ultraviolet light in the wavelength range from 10 nm to 400 nm according to the testing method specified in JIS K 7361-1. Since the ultraviolet rays are light with a wavelength which cannot be recognized by human eyes, the ultraviolet rays are not necessary for the user to check the remaining amount of ink. Accordingly, the ultraviolet light transmittance is preferably kept as low as possible, preferably equal to or less than the visible light transmittance. The transmittance reducing film 06 may include a plurality of films laminated on each other which specifically attenuate light in respective different wavelength regions.

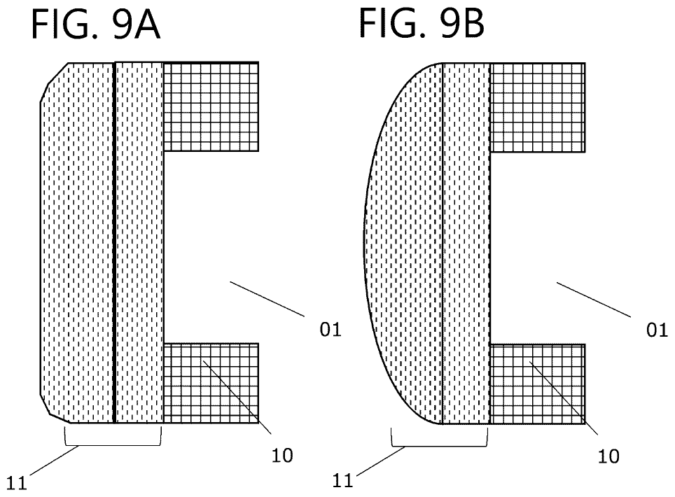

As for the strength, it is necessary for the container to retain the liquid and to withstand at least normal use without damage. Also, as shown in FIGS. 9A and 9B, only at the region corresponding to the cut-out window 01 on the inner side of the resin layer 11 (the side of the container in contact with the ink), the region corresponding to the cut-out window 01 is made thicker than the other regions, which improves the strength of the window portion. As a method for forming such a thick part, the resin layer 11 may be formed or applied to be thick only on the window portion when the member formed by laminating the resin layer 11 and the paper layer 10 is still in the form of a sheet before forming the container. If the ink container 00 has a complicated shape such as a bottle, a material may be sprayed from the inside of the container to the window portion.

It is preferable that the size of the region where the resin layer 11 has an increased thickness is at least the same size as that of the window portion. Furthermore, the size is preferably slightly larger than that of the window portion in order to surely suppress the entry of light. In the figure, in the region corresponding to the window portion, the resin layer 11 is raised to the inside of the container (toward the liquid side), thereby increasing the thickness of the resin layer 11. In this case, since the thickness of the paper layer 10 does not need to be changed, only the resin layer 11 needs to be processed, which makes the manufacturing easy. Meanwhile, the resin layer 11 may be raised toward the outside of the container.

### Advantageous Effect of Present Embodiment

As described above, in the embodiment, the container includes a paper material including the resin layer 11 and the paper layer 10 laminated on each other. According to the structure in the embodiment, since there is no adhesion part using an adhesive inside the container that comes into contact with ink, for example peeling of the film due to deterioration, or leakage of ink from the holes can be prevented. Furthermore, in the present embodiment, the window is covered with a film having a low total light transmission, so that the content can be prevented from changing due to the external light 05.

According to the present disclosure, it is possible to produce the ink container 00 that is resistant to ink-induced deterioration, prevents ink degradation 21 due to light, and allows the amount of content to be visually recognized. Since the ink container 00 offers high visibility for its content, the disadvantage specific to paper container that the content is not visible can be overcome, which allows for the replacement of plastic containers with paper containers.

### Second Embodiment

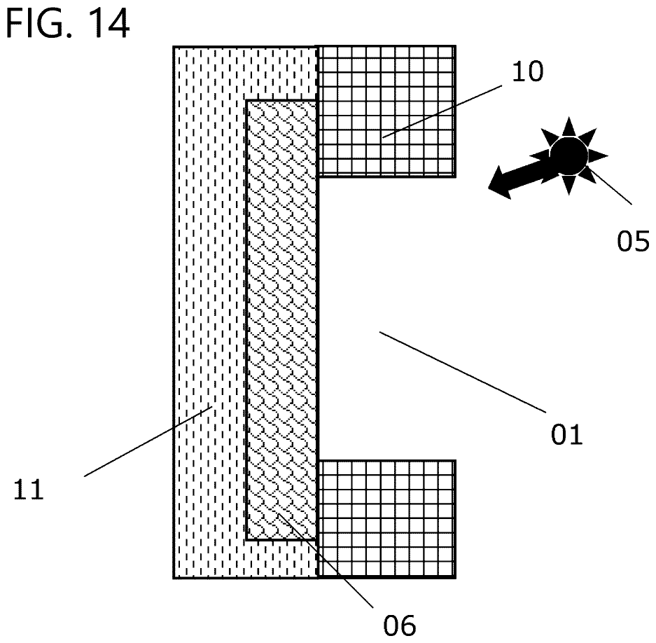

A second embodiment will be described with reference to FIGS. 14 to 18. The descriptions of the same configurations as those in the first embodiment may not be repeated in some cases.

FIG. 14 shows an example of the layer structure of the ink container 00 according to the embodiment. The differences from the first embodiment will be mainly described. In the ink container 00 having an ink storage portion including the resin layer 11 resistant to ink-induced deterioration and the paper layer 10 laminated on each other, only the paper layer 10 is cut out to form a cut-out window 01 for checking the content, similarly to the first embodiment. In addition, in this embodiment, a layer of the transmittance reducing film 06 is provided between the resin layer 11 and the paper layer 10. As long as it can be stably fixed, the transmittance reducing film 06 may be arranged in any manner, for example, adhered or heat-welded. The film arrangement location is at least a position that covers the cut-out region that is to be cut out as a window portion. Further, the film is preferably arranged at a position covering the peripheral edge of the cut-out region.

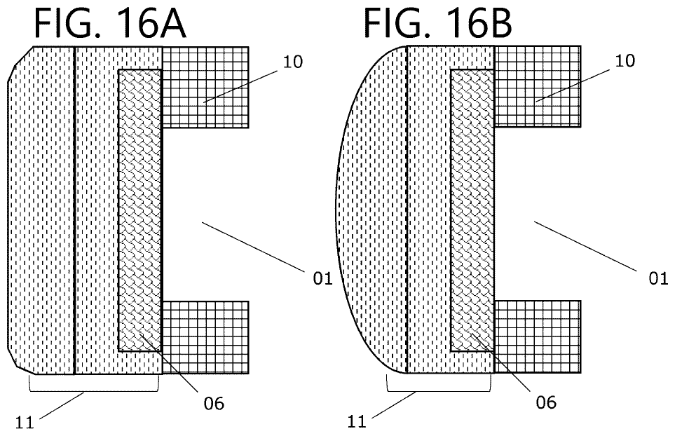

The resin layer 11 is uniformly provided inside the container. Therefore, there is no concern about film peeling that would otherwise be caused by the deterioration of the adhesion part resulting from the penetration of acidic or alkaline ink. Note that, as shown in FIGS. 16A and 16B, the resin layer 11 is formed to be thick only around the cut-out window 01 inside the container, similarly to the first embodiment, and the strength of the window portion is improved.

FIG. 15 shows the appearance of the cut-out window 01 in the present embodiment. When viewed from the outside, the transmittance reducing film 06 is provided over the entire area of the cut-out window 01. Accordingly, the influence of the external light 05 can be suppressed. The size of the film 06 is preferably larger than at least the contour of the window. The properties, materials, and structures of the transmittance reducing film 06 are similar to those of the first embodiment.

### Advantageous Effect of Present Embodiment

According to the present embodiment, the ink container 00, which includes an ink storage portion, an inner layer made of the resin layer 11, and an outer layer made of the paper layer 10, can be provided with the cut-out window 01 for checking the remaining amount and color of the ink from the outside. At the time, since the portion in contact with the ink is entirely covered with the resin layer 11, it is possible to prevent ink seeping into the adhesive, film peeling, and ink leakage. By covering the window portion with the transmittance reducing film 06, incidence of light from the outside can be suppressed, and ink degradation can be prevented.

### Third Embodiment

A third embodiment will be described. The descriptions of the same configurations as those in the first and second embodiments may not be repeated in some cases.

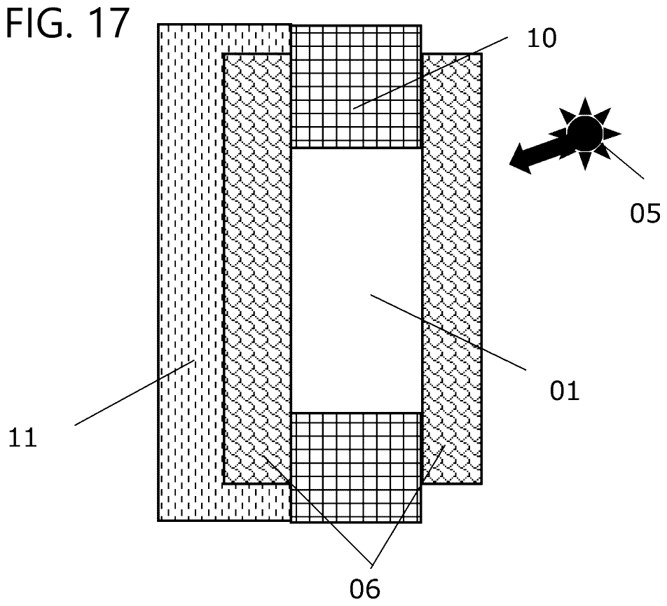

An example of a layer structure of the ink container 00 in the present disclosure is shown in FIG. 17. The differences from the second embodiment will be mainly described. In the ink container 00 including the resin layer 11 and the paper layer 10 laminated on each other, a cut-out is provided only in the paper layer 10, and the transmittance reducing film 06 is provided between the paper layer 10 and the resin layer 11, similarly to the second embodiment. Thus, the adhesion part is not exposed to the ink, so that the ink-induced deterioration of the adhesion part can be prevented.

Furthermore, in the embodiment, the transmittance reducing film 06 is provided on the periphery of the cut-out window 01 also from the outside of the container. That is, in the embodiment, the film is provided on both the inside and outside of the window portion, and the double structure can enhance the effect of preventing external light. The film used on the outside has a size larger than the contour of the window. Also, the inner and outer films of the container may share their functions.

### Advantageous Effect of Present Embodiment

According to the present embodiment, in a structure having a cut-out window provided on a part of paper of an ink container in which an inner layer is made of a resin layer and an outer layer is made of paper, ink-induced deterioration of an adhesion part can be prevented. Further, by covering the window portion with the transmittance reducing film 06, incidence of light from the outside is suppressed and ink degradation is prevented.

### Fourth Embodiment

A fourth embodiment will be described. The descriptions of the same configurations as those in the first to third embodiments may not be repeated.

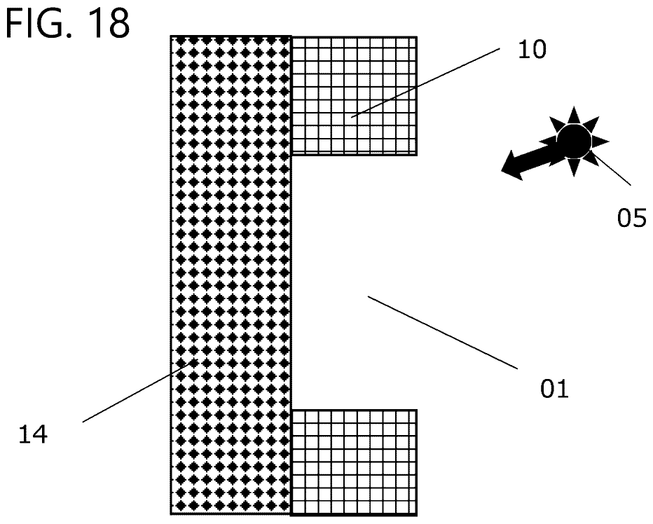

An example of a layer structure of the ink container 00 according to the present disclosure is shown in FIG. 18. The differences from the first embodiment will be mainly described. In the ink container 00 having a resin layer 14 and a paper layer 10 laminated on each other, a cut-out is provided only in the paper layer 10 to form a cut-out window 01 for checking the content. In this embodiment, instead of providing the transmittance reducing film 06, the resin layer 14 serves to reduce the transmittance of external light 05. More specifically, the resin layer 14 in the present embodiment has the function of reducing the transmittance of the external light 05 at least in the region of the cut-out window 01 and its periphery. For this purpose, the resin layer 14 includes laminated layers that reduce the transmittance of the external light 05. Alternatively, the material of the resin layer 14 may contain a component that reduces the transmittance of the external light 05.

### Advantageous Effect of Present Embodiment

According to the present embodiment, the ink container 00, which includes the ink storage portion, an inner layer made of the resin layer 14, and an outer layer made of the paper layer 10, can be provided with the cut-out window 01 for checking the remaining amount and color of the ink from the outside. At the time, since the portion in contact with the ink is entirely covered with the resin layer 14, it is possible to prevent ink seeping into the adhesive, film peeling, and ink leakage. Further, the resin layer 14 of the ink storage portion includes a layer having low total light transmittance, thereby suppressing incidence of light from the outside and preventing ink degradation.

### Container Shape to Which Present Embodiment can be Applied

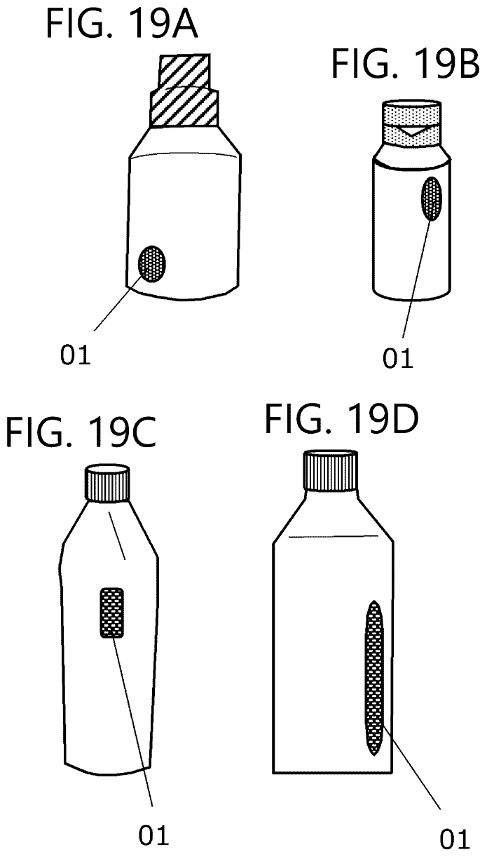

An example of a container shape to which the features of the present disclosure can be applied is shown in FIGS. 19A to 19D to 23A and 23B. As shown in these figures, the shape and size of the container, the position and size of the window portion, and the sealing method with the plug and the lid may vary. Also, the manufacturing method is not limited to the following example.

FIGS. 19A to 19D show examples of bottle-shaped ink containers. As one example of a method for manufacturing a bottle-shaped container, a portion of the resin layer 11 can be produced through molding or injection molding, followed by fitting or wrapping the paper layer 10 provided with a window portion, over it. Then, the transmittance reducing film 06 can be attached using an adhesive.

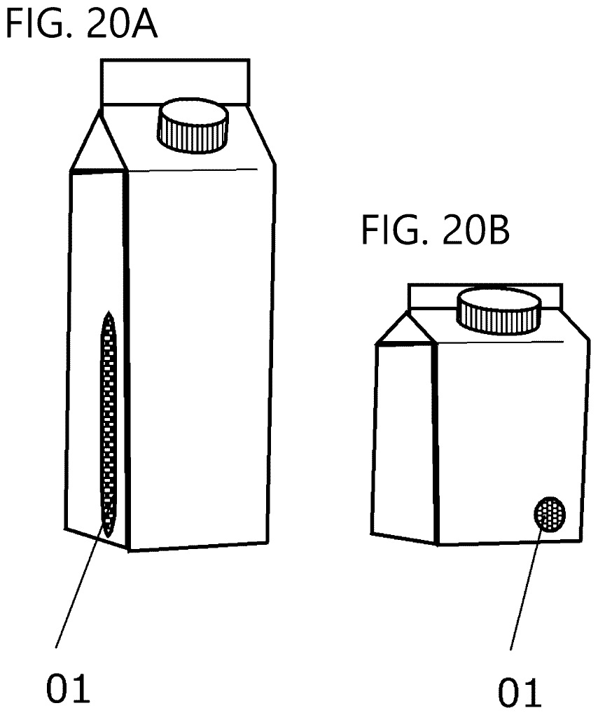

FIGS. 20A and 20B show examples of roof-shaped ink containers. The roof-shaped container can be manufactured similarly to a beverage carton. Specifically, after forming a composite material sheet including the resin layer 11, the paper layer 10 with a hole to be a window portion, and the transmittance reducing film 06 laminated on each other, the sheet is assembled into the desired container shape.

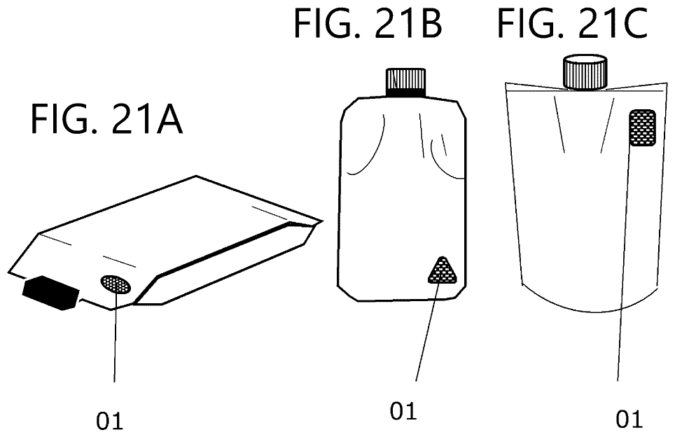

FIGS. 21A to 21C show examples of bag-shaped ink containers. Also in this case, the resin layer 11, the paper layer 10, and the transmittance reducing film 06 are laminated and assembled in the shape of a pouch as shown in the figures.

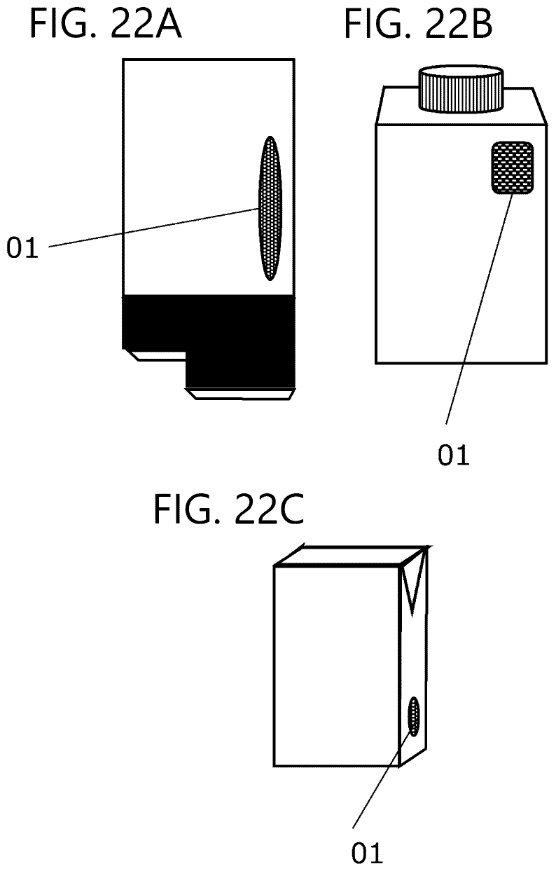

FIGS. 22A to 22C show examples of a brick-shaped ink container. The brick-shaped container may be manufactured similarly to the case of, for example, the roof-shaped container. Alternatively, a resin pack may be pressed into the outer frame of the paper container.

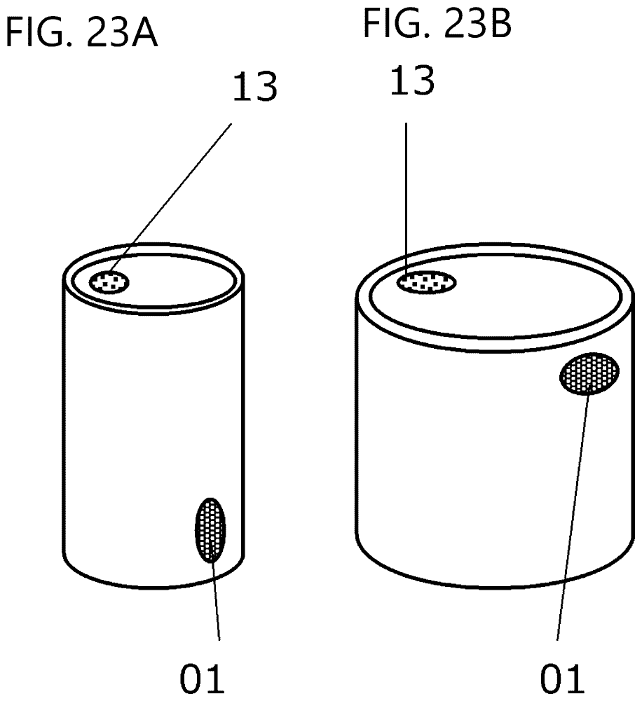

FIGS. 23A and 23B are examples of can-like cylindrical ink containers. The cylindrical container may be manufactured by fitting an inner container made of resin into an outer container made of paper or adhering a paper material to the outer periphery of the container made of resin, similarly to the case of the bottle-shaped container.

The shape of the plug is not limited to that of the plug 12 shown in FIGS. 2A to 2C. The cap may be used as shown in FIGS. 19A to 19D, 20A, and 20B, the container material itself may be folded for sealing, or the seal material 13 may be used for sealing as shown in FIGS. 23A and 23B.

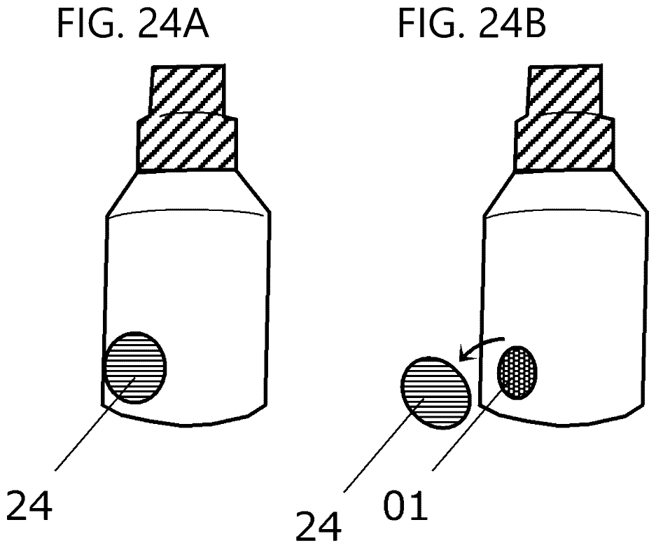

In the above description, the transmittance reducing film 06 is provided on the outer side of the container than the resin layer 11 in the window portion, or the resin layer 11 has the function of preventing external light. However, a different structure may be considered if light can be prevented from entering through the window portion. For example, an opening/closing member 24 may be provided that allows the window portion to be opened/closed. The opening/closing member 24 prevents the external light 05 when in the closed state shown in FIG. 24A and allows the state of ink to be visually recognized from the outside through the cut-out window 01 when in the open state shown in FIG. 24B. Examples of the opening/closing member 24 include a shutter, a seal, and a cap.

The method for checking the inside of the container is not limited to visual recognition by the user. That is, “visual recognition” herein includes an optical method, for example, imaging the container appearance with a camera and analyzing the obtained image.

As described above, according to the configurations in the described embodiments of the present disclosure, it is possible to produce the ink container 00 that allows the content to be checked through a window while preventing ink-induced deterioration of the adhesion part between the window film and the paper container. Furthermore, it can prevent ink degradation caused by light.

Since the ink container 00 allows the content to be visually recognized from the outside, the disadvantage specific to the paper container that the content cannot be viewed can be eliminated, and the plastic container can be replaced with the paper container. Accordingly, in an ink container having a window portion, it is possible to prevent problems such as ink-induced deterioration at the window adhesion part and changes in the content due to light penetration into the container.

According to the features of the present disclosure, the transition from the plastic containers to paper containers (including a container of a composite material of paper and plastic with a lower plastic ratio than conventional products) can be promoted. At least, the amount of plastic used can be reduced compared to conventional cases. The technologies described in this specification have the potential to contribute to the achievement of a sustainable society, such as a decarbonized society/circular society.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2024-067338, filed on Apr. 18, 2024, which is hereby incorporated by reference wherein in its entirety.

What is claimed is:

1. A container comprising:
a storage portion configured to store liquid ink; and
a supply portion configured to supply the ink stored in the storage portion to a recording device, wherein
the storage portion has a layer structure having a resin layer that is an inner layer and a paper layer that is a layer facing the outside of the container,
the paper layer is provided with an opening,
the ink stored in the storage portion can be visually recognized from the outside of the container through the opening, and
the resin layer has a greater thickness in a region corresponding to the opening than in other regions.

2. The container according to claim 1, wherein in the storage portion, only the resin layer is in contact with the ink.

3. The container according to claim 1, wherein the resin layer is raised toward inside of the container to have a thickness increased in the region corresponding to the opening.

4. The container according to claim 1, wherein a film for reducing light transmittance is provided outside the resin layer in the region corresponding to the opening.

5. The container according to claim 4, wherein the film is provided at least in one of a position outside the resin layer and inside the paper layer and a position outside both the resin layer and the paper layer.

6. The container according to claim 4, wherein the film has light transmittance of 40% or less to visible light and ultraviolet light.

7. The container according to claim 6, wherein the film has a lower transmittance for ultraviolet light than for visible light.

8. The container according to claim 4, wherein the light transmittance through the film and the resin layer, as measured from outside the container toward inside of the storage portion, is 20% or less.

9. The container according to claim 1, wherein in the region corresponding to the opening, an opening/closing member configured to allow the ink in the storage portion to be visually recognized when in an open state is provided.

10. The container according to claim 1, wherein the light transmittance through the opening and the resin layer, as measured from outside the container toward inside of the storage portion, is 20% or less.
